(19) United States
(12) Patent Application Publication
(10) Pub. No.: US 2026/0048353 A1
(43) Pub. Date: Feb. 19, 2026

(54) METHOD AND APPARATUS FOR ENHANCED DROPLET CAPTURE WITH INTERNAL RADIALLY PROTRUDING FIBERS

(71) Applicant: Northwestern University, Evanston, IL (US)

(72) Inventors: Leyun Feng, Evanston, IL (US); Ria N. Patel, Lutz, FL (US); Kyoo-Chul Kenneth Park, Evanston, IL (US)

(21) Appl. No.: 19/302,728

(22) Filed: Aug. 18, 2025

Related U.S. Application Data
(60) Provisional application No. 63/683,832, filed on Aug. 16, 2024.

(51) Int. Cl. B01D 46/00

(52) U.S. Cl. CPC B01D 46/0031; B01D 2239/10; B01D 2239/1225; B01D 2239/1233; B01D 2273/30; B01D 2275/10; B01D 2275/201

(57) ABSTRACT

A liquid collection system includes a base through which a gas flows. The liquid collection system also includes a plurality of fibers extending from the base such that the plurality of fibers extend toward one another, where the plurality of fibers are positioned capture liquid that is present in the gas that flows through the base.

### CROSS-REFERENCE TO RELATED APPLICATION

The present application claims the priority benefit of U.S. Provisional Patent App. No. 63/683,832 filed on Aug. 16, 2024, the entire disclosure of which is incorporated by reference herein.

### BACKGROUND

During industrial and manufacturing processes, droplets of water and other liquid molecules may become trapped in the air or other gases, resulting in entrapment. Mist eliminators, or demisters, are used to help remove mists and other liquids generated during such industrial and manufacturing processes. There exist various different types of mist eliminators that can be used to help remove the generated and/or entrapped mist. For example, wire mesh mist eliminators remove droplets from dirty air that is forced through multiple mesh layers. A vane mist eliminator utilizes parallel plates arranged in a wavy formation to attract and separate droplets from a gas. A filter bed mist eliminator uses diffusion through a filter to perform demisting.

### SUMMARY

An illustrative liquid collection system includes a base through which a gas flows. The liquid collection system also includes a plurality of fibers extending from the base such that the plurality of fibers extend toward one another, where the plurality of fibers are positioned capture liquid that is present in the gas that flows through the base.

In one embodiment, the base is a cylinder. In another embodiment, the system includes a fan that causes the gas to flow through the base. In another embodiment, the system includes a container to capture the collected liquid. In one embodiment, the plurality of fibers comprises a first plurality of fibers that form a first filter layer within the base, and the system also includes a second plurality of fibers extending from the base that form a second filter layer within the base. In another embodiment, the first filter layer and the second filter layer have different numbers of fibers. In another embodiment, the second filter layer is offset from the first layer by a rotational angle theta.

In one embodiment, the plurality of fibers includes fibers that vary in length. In another embodiment, the plurality of fibers includes fibers that vary in diameter. In another embodiment, at least one fiber in the plurality of fibers is tapered in diameter. In another embodiment, at least one fiber in the plurality of fibers is formed from interconnected truncated cones. In another embodiment, at least one fiber in the plurality of fibers comprises a chenille stem. In another embodiment, the base comprises a hexagonal base, and the system includes a plurality of coplanar hexagonal bases mounted within a cylinder, where each of the hexagonal bases includes a distinct plurality of fibers.

An illustrative method of forming a liquid collection system includes forming a base through which a gas can flow. The method also includes mounting a plurality of fibers to the base such that the plurality of fibers extend toward one another, where the plurality of fibers are positioned to capture liquid that is present in the gas.

In one embodiment, the method includes forming the plurality of fibers such that the plurality of fibers includes fibers that vary in length. In another embodiment, the method includes forming the plurality of fibers such that the plurality of fibers includes fibers that vary in diameter. In another embodiment, the plurality of fibers comprises a first plurality of fibers that form a first filter layer within the base, and the method includes mounting a second plurality of fibers to the base to form a second filter layer within the base. In another embodiment, mounting the plurality of fibers comprises mounting at least one fiber at an angle gamma relative to the base. In another embodiment, the plurality of fibers are mounted such that different fibers are mounted at different angles relative to the base. In another embodiment, at least one fiber in the plurality of fibers comprises a chenille stem.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A depicts a first experimental setup that utilizes a fan and a camera at opposite ends of a wind tunnel that is positioned vertically such that the collected liquid flow is in the downward direction in accordance with an illustrative embodiment.

FIG. 1B depicts a second experimental setup that utilizes a fan and a camera at opposite ends of a wind tunnel that is positioned horizontally such that the collected liquid flow moves from left to right in accordance with an illustrative embodiment.

FIG. 1C depicts a third experimental setup that involves a fan and a collection container at opposite ends of a wind tunnel that is positioned vertically such that the collected liquid flow moves in the downward direction in accordance with an illustrative embodiment.

FIG. 1D depicts a fourth experimental setup in which droplets generated from a humidifier are directly transported into the middle of a wind tunnel via a connecting pipe in accordance with an illustrative embodiment.

FIG. 1E depicts a fifth experimental setup in which droplets generated from a humidifier are directly transported via a connecting pipe into a wind tunnel in a manner that allows only for positive flow in accordance with an illustrative embodiment.

FIG. 1F is a table that depicts results of testing a mist collection filter under an upwards flow condition in accordance with an illustrative embodiment.

FIG. 2A depicts a tube of the wind tunnel inclined at an angle alpha and holding a sample filter in accordance with an illustrative embodiment.

FIG. 2B depicts the sample filter as a cylindrical unit containing a planar mesh in accordance with an illustrative embodiment.

FIG. 2C depicts a second case in which the sample filter is a cylindrical unit with fibers protruding radially from the walls in accordance with an illustrative embodiment.

FIG. 2D depicts a configuration in which multiple fiber units are stacked in accordance with an illustrative embodiment.

FIG. 3 depicts various types of uniform and non-uniform cross sections of the fiber in accordance with an illustrative embodiment.

FIG. 4 shows top and oblique views of a basic sample filter, a sample filter with varied fiber diameter and fiber number, a sample filter with varied fiber length, and a sample filter with varied layers in accordance with an illustrative embodiment.

FIG. 5 shows images of fog collection results using a mesh structure in accordance with an illustrative embodiment.

FIG. 6 shows droplet formulation per timestamp at a first fiber layer, using 6, 12, 18, and 24 fibers per layer in accordance with an illustrative embodiment.

FIG. 7A depicts the transport of water droplets over a span of t=5 s, with a windspeed of v=8 m/s, for a droplet collected on a flexible sample, of fiber layer N=1, fibers per layer n=18, fiber diameter d_{fiber}=0.5 m, and fiber length l_{fiber}=12 mm, placed horizontally (fiber angle γ=0), for one fiber in accordance with an illustrative embodiment.

FIG. 7B depicts the experiment of FIG. 7A with two fibers in accordance with an illustrative embodiment.

FIG. 7C depicts the experiment of FIG. 7A with three fibers in accordance with an illustrative embodiment.

FIG. 7D depicts the experiment of FIG. 7A with four fibers in accordance with an illustrative embodiment.

FIG. 8 depicts fiber deformation for various fiber diameters resulting from fog droplet collection through wind speed v=8 m/s in accordance with an illustrative embodiment.

FIG. 9 depicts fiber deformation as a result of droplet formation through a wind speed v=8 m/s, for horizontally placed flexible samples for fiber layer N=1, fibers per layer n=6, fiber diameter d_{fiber}=0.5 mm, and projected fiber length l_{fibercosγ}=12 mm, for varying angles between the fiber and the vertical plane γ in accordance with an illustrative embodiment.

FIG. 10 shows fiber deformation as a result of droplet formation through varying wind speeds, for horizontally placed flexible samples of fiber layer number N=1, fibers per layer n=6, fiber angle γ=0, fiber diameter d_{fiber}=0.5 mm, and fiber length l_{fiber}=12 mm (indicated by a white circle) in accordance with an illustrative embodiment.

FIG. 11A shows droplet transport after collection of water droplets through a wind speed v=8 m/s, for fiber layer N=1, fibers per layer n=18, fiber angle γ=0, fiber diameter d_{fiber}=0.5 mm and fiber length l_{fiber}=12 mm on a horizontally placed flexible sample filter in accordance with an illustrative embodiment.

FIG. 11B shows droplet transport after collection of water droplets through a wind speed v=8 m/s, for fiber layer N=1, fibers per layer n=18, fiber angle γ=0, fiber diameter d_{fiber}=0.5 mm and fiber length l_{fiber}=12 mm on a horizontally placed rigid sample filter in accordance with an illustrative embodiment.

FIG. 12A shows a reduction of droplet transport efficiency through a first phenomenon where collected water drops before reaching the fiber tip, indicated by a white box, in accordance with an illustrative embodiment.

FIG. 12B shows a reduction of droplet transport efficiency through a second phenomenon where water droplets transport in an inverse direction, indicated by a white circle, in accordance with an illustrative embodiment.

FIG. 13A shows droplet collection at fiber tips between two fibers for a flexible sample filter (left) and a rigid sample filter (right) in accordance with an illustrative embodiment.

FIG. 13B shows droplet collection at fiber tips between three fibers for a flexible sample filter (left) and a rigid sample filter (right) in accordance with an illustrative embodiment.

FIG. 14 shows droplet collection through a wind speed v=8 m/s, for various fiber layers, various fibers per layer, fiber angle γ=0, fiber diameter d_{fiber}=0.5 mm and fiber length l_{fiber}=12 mm on a horizontally placed multi-layer hair structure sample in accordance with an illustrative embodiment.

FIG. 15A shows a fiber filter that is directly 3D printed using Anycubic black UV Resin in accordance with an illustrative embodiment.

FIG. 15B shows a fiber filter made by inserting aluminum wires into a circular base in accordance with an illustrative embodiment.

FIG. 15C shows a fiber filter made by inserting chenille stems into a circular base in accordance with an illustrative embodiment.

FIG. 15D shows a fiber filter made by inserting modified chenille stems with less hair into a circular base in accordance with an illustrative embodiment.

FIG. 16A shows the before and after result of collecting fog with thin hairs of modified chenille stems with less hair in accordance with an illustrative embodiment.

FIG. 16B shows the before and after result of collecting fog with thin hairs of regular chenille stems in accordance with an illustrative embodiment.

FIG. 17A shows a first view of the fast transport on fibers made of chenille stems after getting wet in accordance with an illustrative embodiment.

FIG. 17B shows a second view of the fast transport on fibers made of chenille stems after getting wet in accordance with an illustrative embodiment.

FIG. 18 shows results of a simulation of sample fiber deformation during fog collection (flow speed is set to 10 m/s) in accordance with an illustrative embodiment.

FIG. 19A depicts dividing the volume of a large pipe into smaller pipes of varying cross-sectional geometries in accordance with an illustrative embodiment.

FIG. 19B shows inserting multiple hair structures in a lattice formation throughout the volume of a larger pipe in accordance with an illustrative embodiment.

### DETAILED DESCRIPTION

The mist elimination market is currently valued at 659.54 million United States Dollars (USD), and is expected to grow to 963 million USD by 2032. There is high demand for this technology to improve process efficiencies, facilitate compliance with stringent environmental regulations, and reduce energy expenditures for recovering water from ambient air. Mist elimination methods also present a promising method for recovering water in arid regions for use in farming, livestock, drinking, etc.

Mist elimination has many applications, and has been identified as being important for recovering valuable resources in chemical processes, protecting downstream equipment from corrosion, reducing worker's health risks from toxins in the mist, and recovering water from ambient air in an energy efficient manner. Current solutions include the use of meshes, fiber beds, cyclones, and baffles to collect and transport water as droplets from mist. In current solutions that utilize collection of droplets, gravitational forces are used to transport the droplets down a surface for eventual collection or removal. In addition to mist collection, these designs can also be applied to relevant fields such as fog collection, dew collection, and natural/artificial microparticles/microfibers capture, including smog capture. A particular example is the use of fog collection at shoreline locations in the Middle East to recover water necessary for the evaporative cooling of solar panels.

The efficiency of mist eliminators heavily depends on environmental conditions such as wind speed and altitude, making consistent collection difficult to achieve. Additionally, maintenance is a significant issue as mesh collectors can quickly become clogged with water droplets or debris, reducing their effectiveness over time and requiring either additional energy input for removal or filter/eliminator replacement. Moreover, the scalability of mist eliminators systems is limited by manufacturing cost and implantability of the designs into the environment. The energy required for pumping and distributing collected water (or other liquid) adds to the overall cost and environmental footprint of mist eliminator systems. Despite these challenges, ongoing research and innovation aim to enhance the efficiency and reliability of mist elimination methods for sustainable water/liquid resource management.

There is a need in the mist elimination market for solutions pertaining to environmental sustainability and air pollution control, in industries such as power generation, chemical development and storage, oil and gas development and storage, and petrochemical development and storage, etc. A large focus within this research area is developing apparatuses to withstand operating conditions with low maintenance costs and a long service life. As discussed above, conventional meshes face clogging on a regular basis and require increased maintenance or energy input for unclogging. As examples of limitations with several existing mist eliminators, fiber bed eliminators cannot be used for vertical gas flow, and can be clogged by poor drainage. Cyclone mist eliminators require high energy input. Baffle eliminators cannot remove droplets with diameters smaller than 3 millimeters (mm), and are highly susceptible to re-entrainment. Therefore, a more cost-effective and efficient solution is required to solve these problems with traditional systems.

Described herein is a solution that uses surface tension of liquid and elasticity of radially extending fibers that protrude from a cylindrical wall to transport the water droplets to the cylinder center under a controlled flow, where the droplets are then transported downward as a result of gravitational forces. In an illustrative embodiment, the system includes one or more sample filters that include hair-like protrusions (i.e., fibers) extending from a base, which can be an interior surface of a cylinder (e.g., pipe) or other shape. The sample filter(s) can be of varying sample layer number (i.e., a plurality of different layers of sample filters can be mounted to the base), sample layer distance (i.e., the distance between different layers of sample filters can be varied), cross-section geometries (e.g., circular, square, hexagon, etc.), fiber length, fiber diameter, and/or fiber angles within each layer.

More specifically, the systems described herein utilize the special geometry of hair-like protrusions (or fibers) extending from a surface to increase the effective contact area between the mist collecting surface and aerosolized water droplets. The adaptable deformation of solid surfaces also facilitates the water collection and transport efficiency under the flow. Various geometries and properties of the protrusions, including angle (i.e., relative to the surface to which the protrusions are mounted), cross-sectional shape (e.g., circular, ovular, square, rectangular, triangular, octagonal, etc.), and rigidity increase the collection and transport ability of the hair-like protrusions. The proposed system can capture droplets effectively and efficiently, at low cost and with low external energy input. The proposed system is also environmentally friendly, easy to manufacture and implement, and adaptable to various apparatuses for implementation.

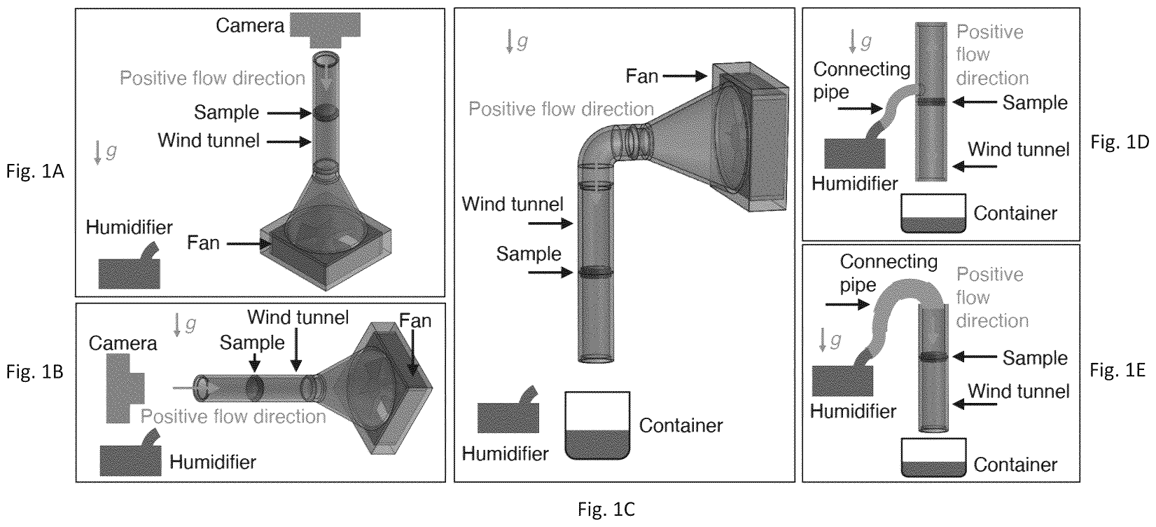

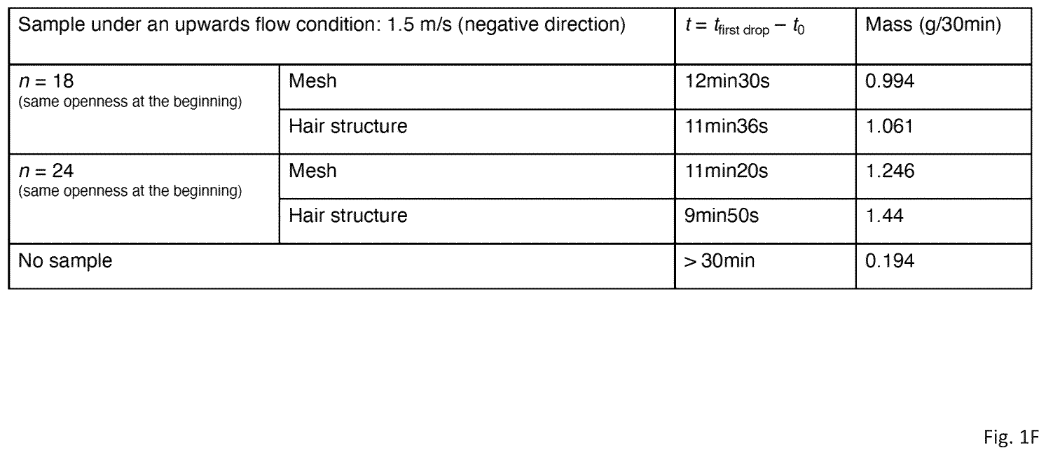

In order to observe and quantify the ability of a sample filter to collect mist droplets, various experimental setups were used. FIG. 1A depicts a first experimental setup that utilizes a fan and a camera at opposite ends of a wind tunnel that is positioned vertically such that the collected liquid flow is in the downward direction in accordance with an illustrative embodiment. FIG. 1B depicts a second experimental setup that utilizes a fan and a camera at opposite ends of a wind tunnel that is positioned horizontally such that the collected liquid flow moves from left to right in accordance with an illustrative embodiment. FIG. 1C depicts a third experimental setup that involves a fan and a collection container at opposite ends of a wind tunnel that is positioned vertically such that the collected liquid flow moves in the downward direction in accordance with an illustrative embodiment. FIG. 1D depicts a fourth experimental setup in which droplets generated from a humidifier are directly transported into the middle of a wind tunnel via a connecting pipe in accordance with an illustrative embodiment. FIG. 1E depicts a fifth experimental setup in which droplets generated from a humidifier are directly transported via a connecting pipe into a wind tunnel in a manner that allows only for positive flow in accordance with an illustrative embodiment.

In the views of FIG. 1, the direction of the force of gravity (g) is depicted with an arrow, as is the positive flow direction of collected liquid (which is bidirectional in FIG. 1D). The sample in the views of FIG. 1 refers to a filter as described herein. To perform tests using the experimental setups shown, the humidifier is used to generate moisture in the air, which is then fed into a wind tunnel that includes a mist collection filter (i.e., sample) mounted therein. In some implementations, a fan is used to help move the moisturized air through the mist collection filter. A container is used in some embodiments to collect the collected liquid so that system efficiency and overall effectiveness can be determined. It is also noted that water can be collected and transported downwards when the samples are tested under an upwards flow condition.

FIG. 1F is a table that depicts results of testing a mist collection filter under an upwards flow condition in accordance with an illustrative embodiment. As shown, water can be collected and transported downwards when the sample is tested under an upwards flow condition. The time for the first collected water drop and the mass of the collected water during 30 min with or without various samples is reported. It was found that higher efficiency of water collection is achieved using samples with hair structures compared with mesh samples. In this experiment, the sample filters were horizontally placed with fiber layer number N=1, fiber diameter d_{fiber}=0.5 mm, fiber length l_{fiber}=12 mm, and fiber angle γ=0.

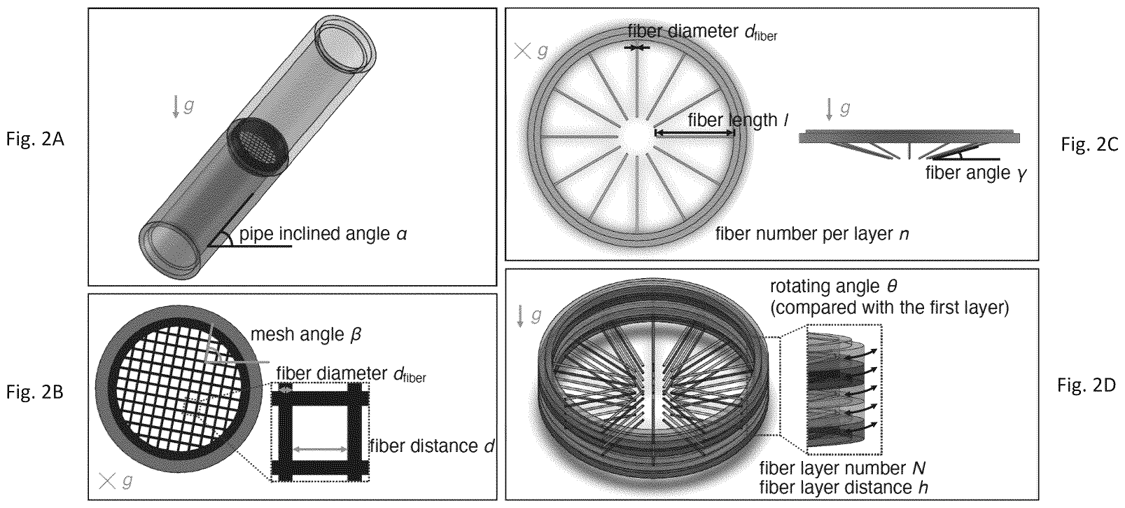

FIG. 2A depicts a tube of the wind tunnel inclined at an angle alpha and holding a sample filter in accordance with an illustrative embodiment. The angle alpha is relative to a ground surface over which the wind tunnel is positioned. FIG. 2B depicts the sample filter as a cylindrical unit containing a planar mesh in accordance with an illustrative embodiment. As shown, the mesh can be rotated to an angle beta relative to the horizontal. The fibers that form the planar mesh have a fiber distance (d) in between fibers and a fiber diameter (d_{fiber}), both of which can vary based on the embodiment. FIG. 2C depicts a second case in which the sample filter is a cylindrical unit with fibers protruding radially inward from the walls in accordance with an illustrative embodiment. The protruding fibers can be rotated to an angle gamma relative to horizontal (i.e., relative to the surface of the base wall). The fibers also have a variable fiber length and fiber diameter. FIG. 2D depicts a configuration in which multiple fiber units are stacked in accordance with an illustrative embodiment. As shown, adjacent fiber units are rotated relative to one another by a rotating angle theta. Specifically, within the assembled sample filter, each layer can be rotated to obtain a different openness of the overall filter system.

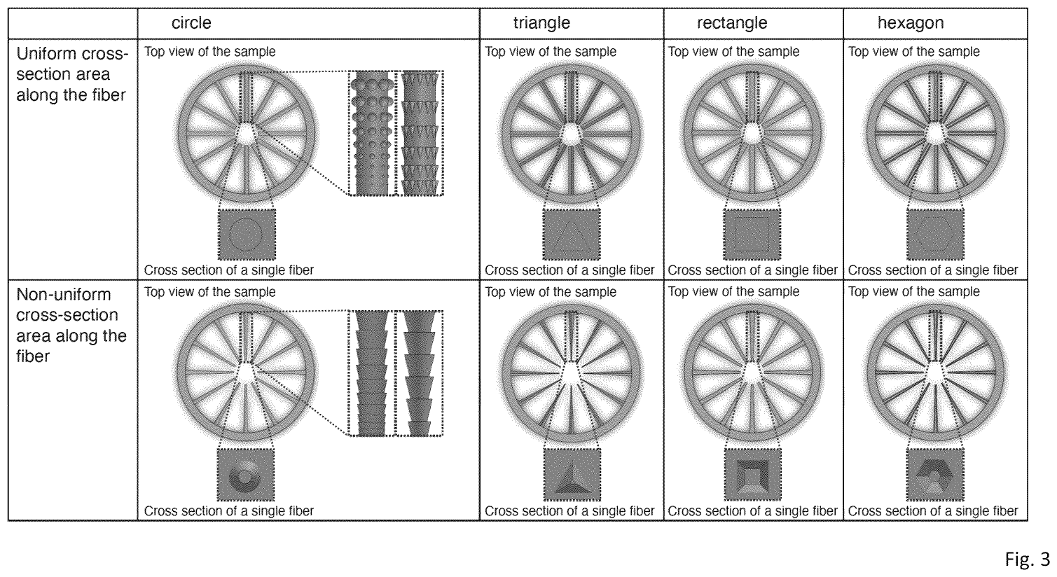

In any of the embodiments, the fibers themselves can either have a uniform cross section area, or a non-uniform, tapered cross sectional area. In other words, the fiber diameter can either be constant over the length of the fiber, or tapered. FIG. 3 depicts various types of uniform and non-uniform cross sections of the fiber in accordance with an illustrative embodiment. As shown, the cross sectional shape can be a circle, triangle, rectangle, hexagon, etc. As also shown, asymmetric micro-structures can be manufactured or mounted on fibers to enhance the liquid transport, as shown in the magnified inset in FIG. 3. The micro-structures can be in the shape of spheres, pyramids, diamonds, cylinders, etc. In one embodiment, the micro-structures can decrease in size along a length of the fiber, with the micro-structures becoming smaller as the fiber extends from the base wall. In one embodiment, the fibers can be made in the form of adjoining truncated cones, as shown in the bottom left inset of FIG. 3. It was found that each geometry performs differently and results in a different fog collection efficiency.

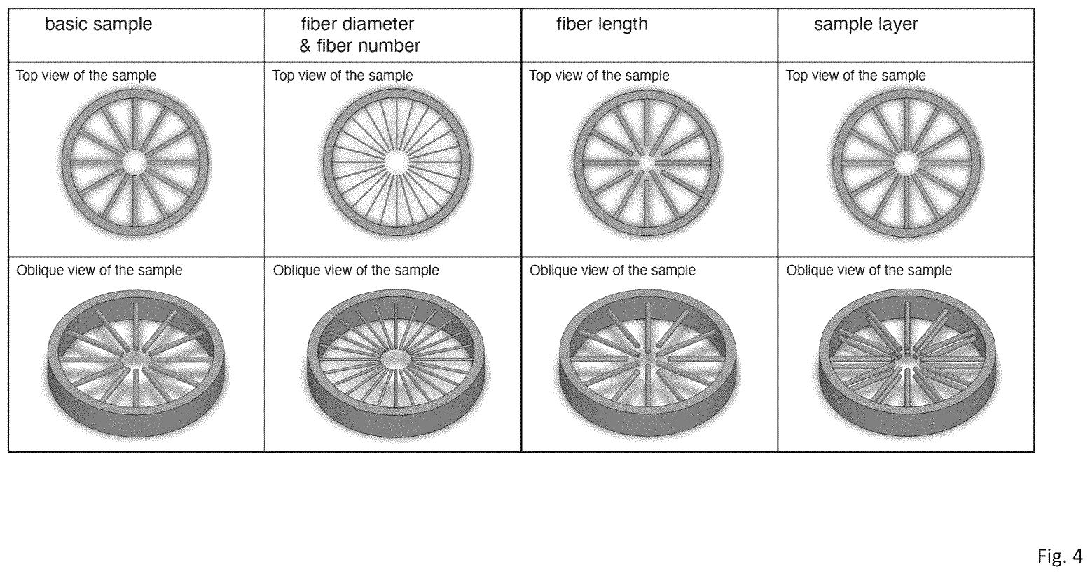

Fiber parameters such as fiber length, fiber diameter, and sample layer number can also be varied within a given sample filter such that different fibers in the filter can have different lengths, different diameters, different numbers of fibers, etc. To compare the efficiency of various samples, these parameters were varied for the same value of (1-Sc), which is defined as openness, where Sc is the Shading Coefficient. FIG. 4 shows top and oblique views of a basic sample filter, a sample filter with varied fiber diameter and fiber number, a sample filter with varied fiber length, and a sample filter with varied layers in accordance with an illustrative embodiment. The examples of FIG. 4 include sample filters with the same openness (before experiments start) as the basic design. However, these sample filters perform differently and result in different fog collection efficiency due to various sample parameters such as fiber length, fiber diameter, and sample layer number.

As discussed above, meshes are one of the most conventional tools used in the mist elimination process. However, when implemented within a pipe, various complications occur, which reduce the efficiency of water collection. For example, when the pipe is horizontally placed (relative to the ground surface), the mesh is submerged in the collected water after some time due to the inefficient water transport within the pipe. When the pipe is vertically placed, it takes quite a long time for the collected water to drop from the mesh as a result of clogging. As discussed below, it was found that higher efficiency of water collection is achieved using samples with hair/fiber structures compared with mesh samples, as shown in the table of FIG. 1F.

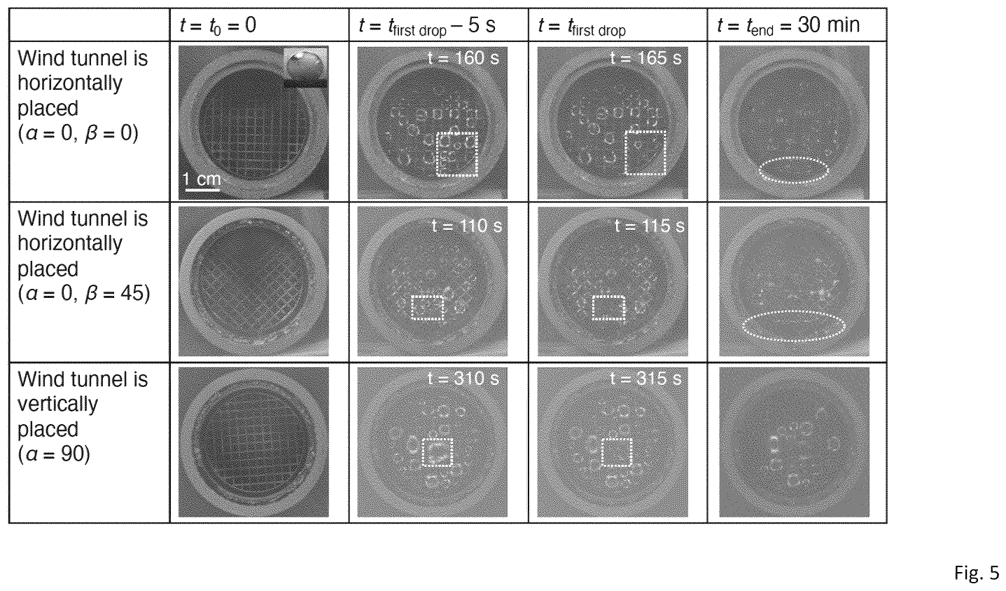

FIG. 5 shows images of fog collection results using a mesh structure in accordance with an illustrative embodiment. In FIG. 5, the contact angle is 82°, fiber diameter d_{fiber}=0.5 mm, and fiber distance d=2 mm, through a wind speed velocity (v)=8 meters per second (m/s), over a period of t=30 minutes. When the wind tunnel is horizontally placed, the mesh would be submerged into the collected water after 30 min due to the inefficient water transport within the pipe, indicated by the white ellipse. When the wind tunnel is vertically placed, it takes a longer time for the collected water to drop from the mesh. The white box indicates that the collected water is to be transported from the mesh for the first time.

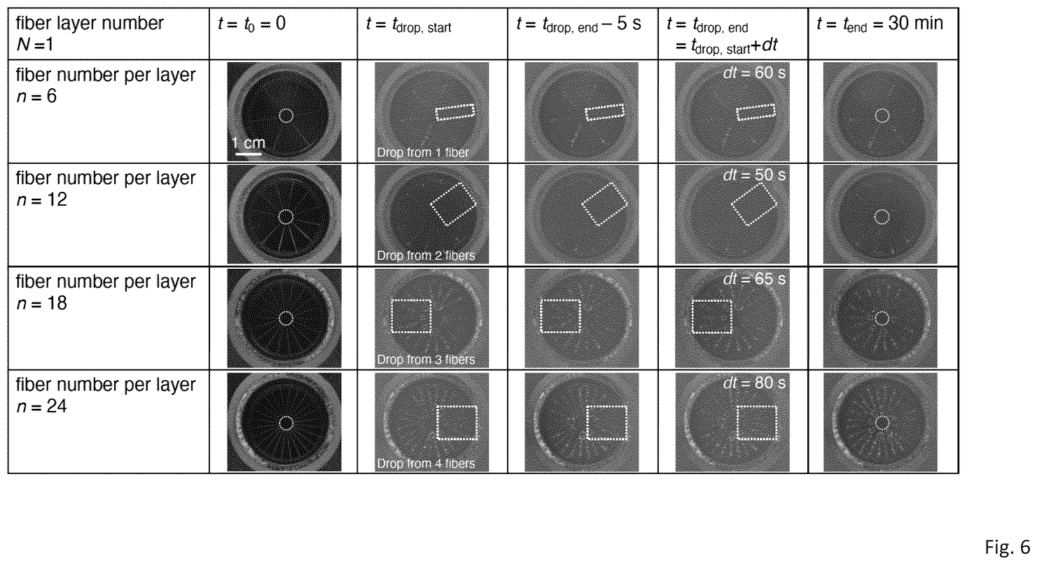

FIG. 6 shows results obtained from the proposed fiber filter. Specifically, FIG. 6 shows droplet formulation per timestamp at a first fiber layer, using 6, 12, 18, and 24 fibers per layer in accordance with an illustrative embodiment. The white circle shows the original place of the fiber tips. The white box shows the collected water dropping from the tip of single fiber or fiber groups. Fiber layer number N=1, and fibers are horizontally positioned (fiber angle γ=0) at the beginning. Fiber diameter d_{fiber} is 0.5 mm and fiber length l_{fiber} is 12 mm. Wind speed is around 8 m/s. In comparison to the mechanism through which droplet collection and clogging occurs in meshes (shown in FIG. 5), FIG. 6 shows that using the proposed system results in large droplets that begin forming on the tip of the fiber, and drop from the tip of the fiber, allowing for further collection of droplets.

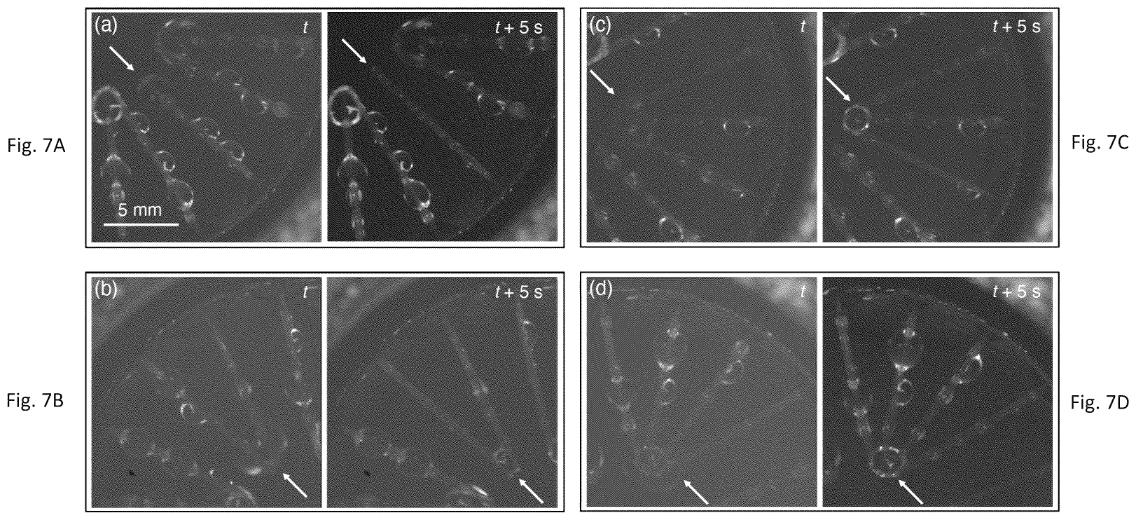

FIG. 7A depicts the transport of water droplets over a span of t=5 s, with a windspeed of v=8 m/s, for a droplet collected on a flexible sample, of fiber layer N=1, fibers per layer n=18, fiber diameter d_{fiber}=0.5 m, and fiber length l_{fiber}=12 mm, placed horizontally (fiber angle γ=0), for one fiber in accordance with an illustrative embodiment. FIG. 7B depicts the experiment of FIG. 7A with two fibers in accordance with an illustrative embodiment. FIG. 7C depicts the experiment of FIG. 7A with three fibers in accordance with an illustrative embodiment. FIG. 7D depicts the experiment of FIG. 7A with four fibers in accordance with an illustrative embodiment. As the number of fibers increases, the volume of the droplet accumulated before dropping by the fiber tip(s) increases. The surface tension of water allows for multiple fibers to collect the same water droplet, forming a cluster, as shown in FIG. 7. It is noted that as the number of fibers in the droplet cluster increases, the size of the accumulated droplet (before dropping) increases.

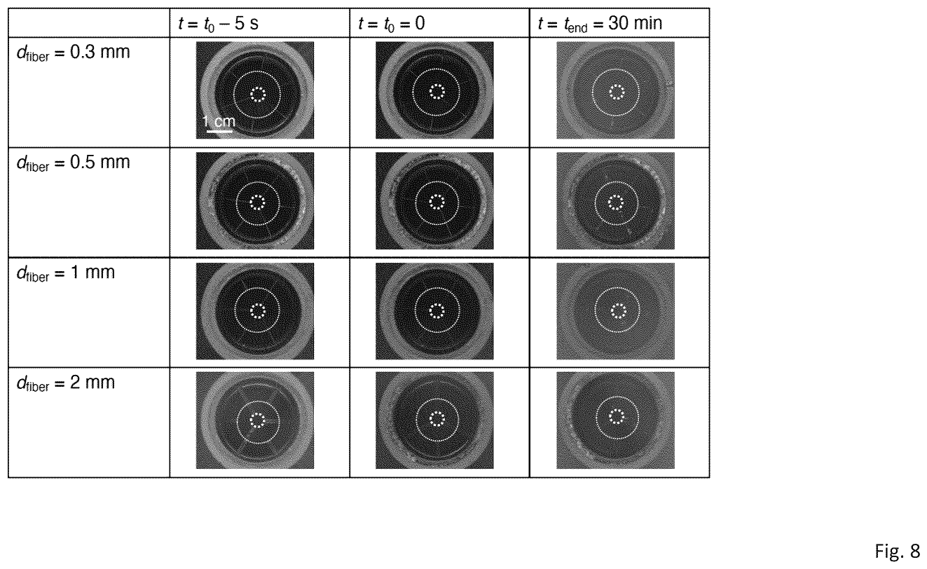

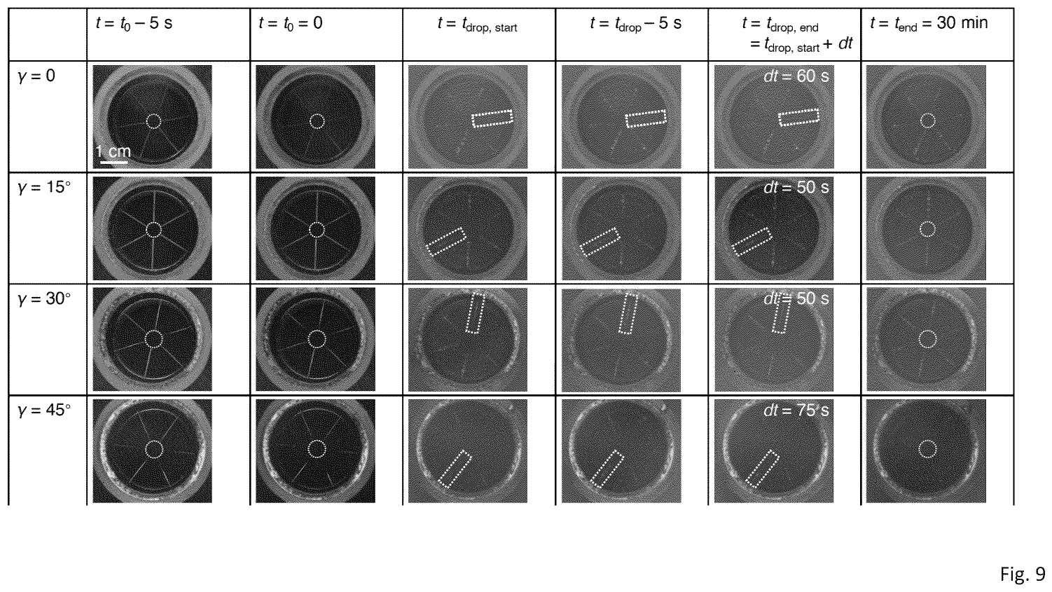

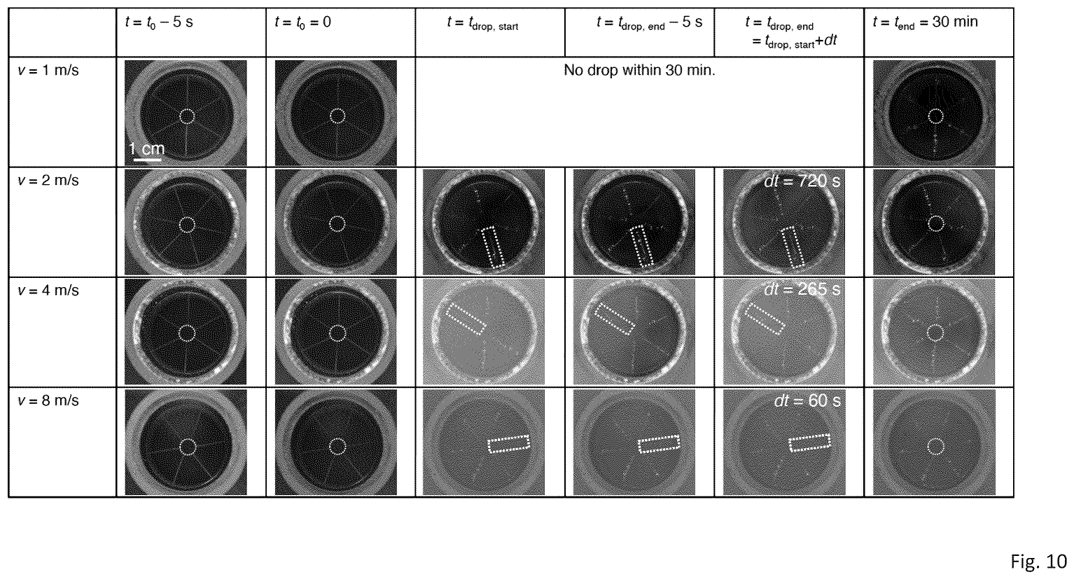

Flexible fibers have been observed to deform as a result of droplet formation, with different sample parameters such as fiber diameter and fiber length (FIG. 8), gamma values (FIG. 9), and under conditions of varying wind speeds (FIG. 10). Fibers of longer length and smaller diameter deform more effectively in comparison to fibers of shorter length and larger diameter under the same wind flow conditions, which facilitates the water transport (FIG. 8). Increased inclination of the fibers also corresponds to increased transport within some fiber inclined angle ranges (FIG. 9). Higher flow velocities correspond to increased liquid transport (FIG. 10).

FIG. 8 depicts fiber deformation for various fiber diameters resulting from fog droplet collection through wind speed v=8 m/s in accordance with an illustrative embodiment. In FIG. 8, the fiber layer number N=1, and the fibers alternate horizontally between long and short fibers (fiber angle γ=0) of fiber length l_{fiber}=12 mm and 6 mm, respectively. This is indicated by a thin white outer circle and thick inner circle, respectively. It was found that thinner and longer fibers deform to a greater extent under the same wind speed.

FIG. 9 depicts fiber deformation as a result of droplet formation through a wind speed v=8 m/s, for horizontally placed flexible samples for fiber layer N=1, fibers per layer n=6, fiber diameter d_{fiber}=0.5 mm, and projected fiber length l_{fibercosγ}=12 mm, for varying angles between the fiber and the vertical plane γ in accordance with an illustrative embodiment. In FIG. 9, the collection and transport of water droplets on a single fiber are demonstrated through the start of droplet formation on a single fiber (t=t_{drop,start}), the formation of multiple droplets, coalesced into a larger droplet on a single fiber, 5 seconds before the droplet falls from the fiber (t_{drop}−5 s), and the fiber after the droplet has fallen (t_{drop,end}). It was observed that inclined fibers corresponded to faster droplet transport.

FIG. 10 shows fiber deformation as a result of droplet formation through varying wind speeds, for horizontally placed flexible samples of fiber layer number N=1, fibers per layer n=6, fiber angle γ=0, fiber diameter d_{fiber}=0.5 mm, and fiber length l_{fiber}=12 mm (indicated by a white circle) in accordance with an illustrative embodiment. The collection and transport of water droplets on a single fiber are demonstrated through the start of droplet formation on a single fiber (t=t_{drop,start}), the formation of multiple droplets, coalesced into a larger droplet on a single fiber, 5 seconds before the droplet falls from the fiber (t_{drop,end}−5 s), and the fiber after the droplet has fallen (t_{drop,end}). It was observed that higher wind speeds correspond with faster dropping (release) of collected water droplets.

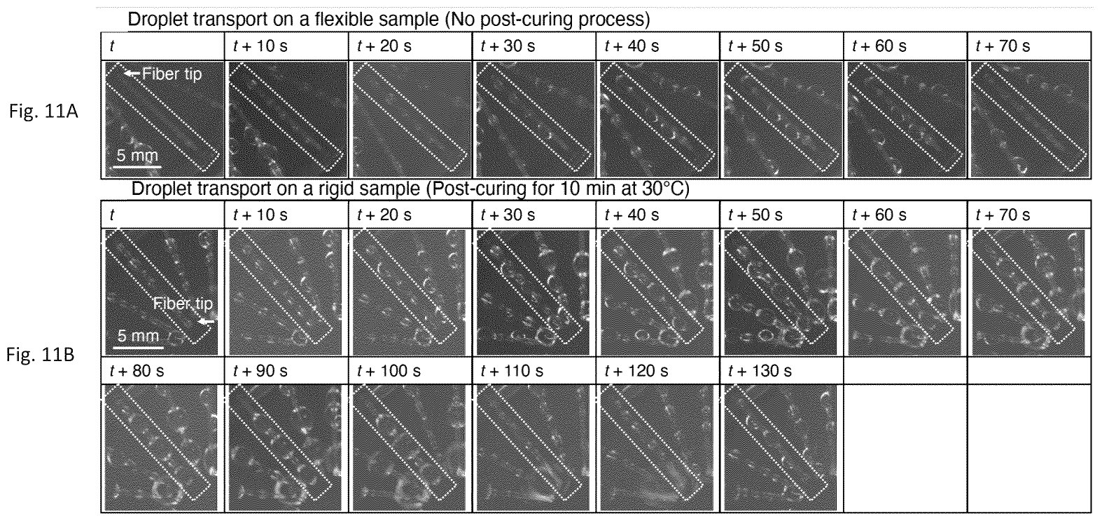

Flexible fibers were also shown to facilitate droplet transport in comparison to rigid fibers due to adaptable deformation. FIG. 11A shows droplet transport after collection of water droplets through a wind speed v=8 m/s, for fiber layer N=1, fibers per layer n=18, fiber angle γ=0, fiber diameter d_{fiber}=0.5 mm and fiber length l_{fiber}=12 mm on a horizontally placed flexible sample filter in accordance with an illustrative embodiment. FIG. 11B shows droplet transport after collection of water droplets through a wind speed v=8 m/s, for fiber layer N=1, fibers per layer n=18, fiber angle γ=0, fiber diameter d_{fiber}=0.5 mm and fiber length l_{fiber}=12 mm on a horizontally placed rigid sample filter in accordance with an illustrative embodiment. As shown, droplet collection and transport time increased for the rigid sample in comparison to the flexible sample. The progression of droplet formation and transportation on a single fiber is indicated by a white box in both FIGS. 11A and 11B. The flexible sample is made without a post-curing process after being 3D printed, and the rigid sample is post-cured for 10 min at 30° C. after being 3D printed.

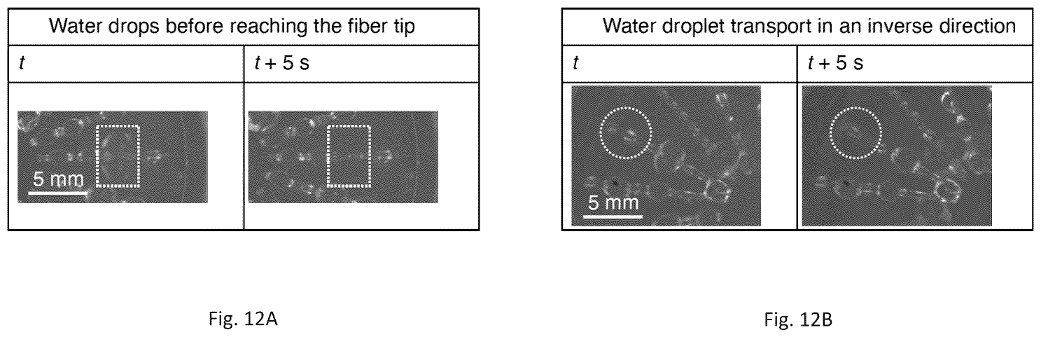

The inefficiency in droplet transport is depicted in FIG. 12, where droplets are seen to drop in advance of reaching the fiber tip, as well as transporting in the inverse direction, towards the base of the fiber. More specifically, FIG. 12 shows demonstrations of reduction of droplet transport efficiency for the collection of water droplets through a wind speed v=8 m/s, for fiber layer N=1, fibers per layer n=18, fiber angle γ=0, fiber diameter d_{fiber}=0.5 mm and fiber length l_{fiber}=12 mm on a horizontally placed rigid sample that was post-cured for 10 min at 30° C. after being printed. FIG. 12A shows a reduction of droplet transport efficiency through a first phenomenon where collected water drops before reaching the fiber tip, indicated by a white box, in accordance with an illustrative embodiment. FIG. 12B shows a reduction of droplet transport efficiency through a second phenomenon where water droplets transport in an inverse direction, indicated by a white circle, in accordance with an illustrative embodiment.

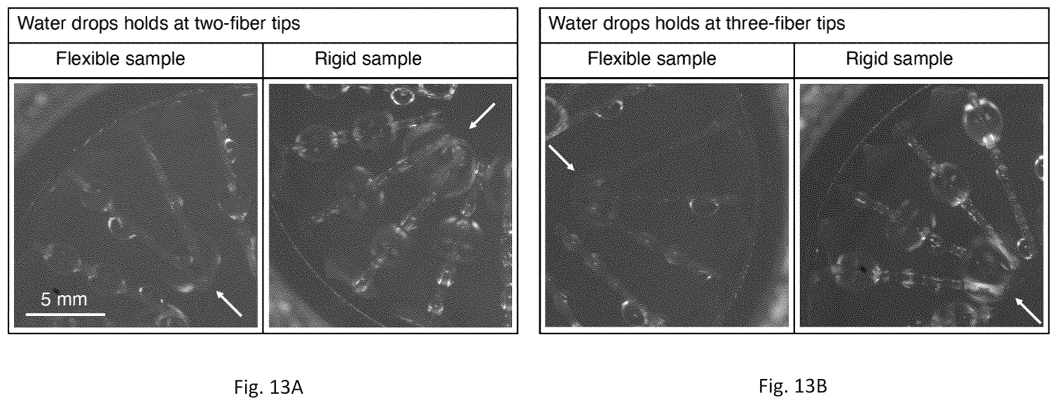

FIG. 13 shows droplet collection at fiber tips through a wind speed v=8 m/s, for fiber layer N=1, fibers per layer n=18, fiber angle γ=0, fiber diameter d_{fiber}=0.5 mm and fiber length l_{fiber}=12 mm on a horizontally placed rigid and flexible sample. FIG. 13A shows droplet collection at fiber tips between two fibers for a flexible sample filter (left) and a rigid sample filter (right) in accordance with an illustrative embodiment. FIG. 13B shows droplet collection at fiber tips between three fibers for a flexible sample filter (left) and a rigid sample filter (right) in accordance with an illustrative embodiment. It was observed that larger droplets were formed at the tips of rigid fibers as compared to the flexible fibers.

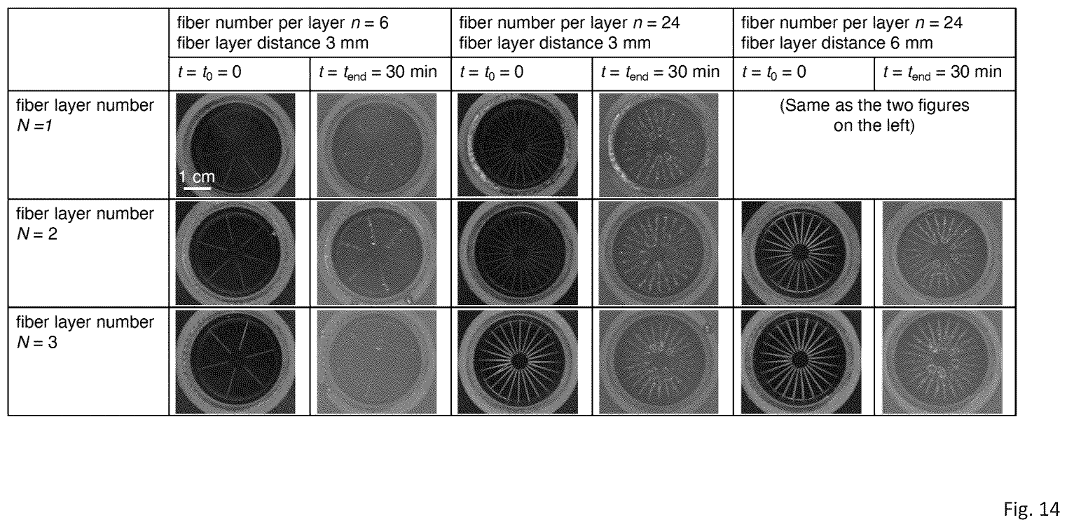

By stacking samples of a single layer of fibers into multiple layers of fibers, fibers not only form clusters within the same layer, but also between different layers. FIG. 14 shows droplet collection through a wind speed v=8 m/s, for various fiber layers, various fibers per layer, fiber angle γ=0, fiber diameter d_{fiber}=0.5 mm and fiber length l_{fiber}=12 mm on a horizontally placed multi-layer hair structure sample in accordance with an illustrative embodiment. In this embodiment, the fibers are connected with each other horizontally and vertically, and result in larger droplet forming before dropping down than through a single layer sample filter.

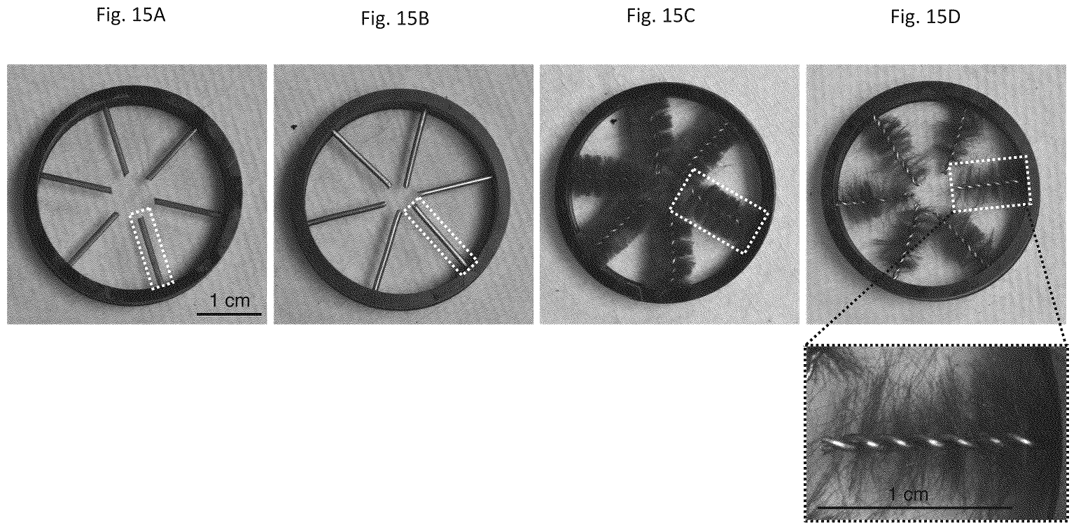

FIG. 15 shows examples of samples with fibers made of different materials. FIG. 15A shows a fiber filter that is directly 3D printed using Anycubic black UV Resin in accordance with an illustrative embodiment. In alternative embodiments, differing types of resin may be used. FIG. 15B shows a fiber filter made by inserting aluminum wires into a circular base in accordance with an illustrative embodiment. FIG. 15C shows a fiber filter made by inserting chenille stems into a circular base in accordance with an illustrative embodiment. FIG. 15D shows a fiber filter made by inserting modified chenille stems with less hair into a circular base in accordance with an illustrative embodiment. It is noted that the unit in the dotted boxes are referred to as one ‘fiber’, and that the one fiber in FIGS. 15C and 15D are composed of two twisted cylindrical wires surrounded by thin hairs protruding along radial direction.

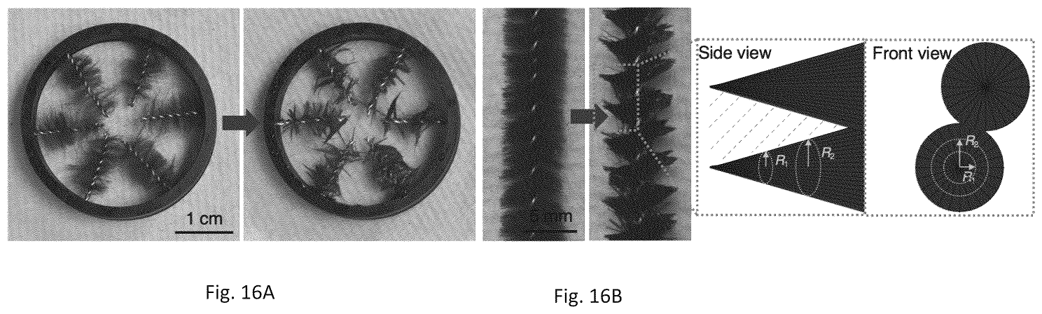

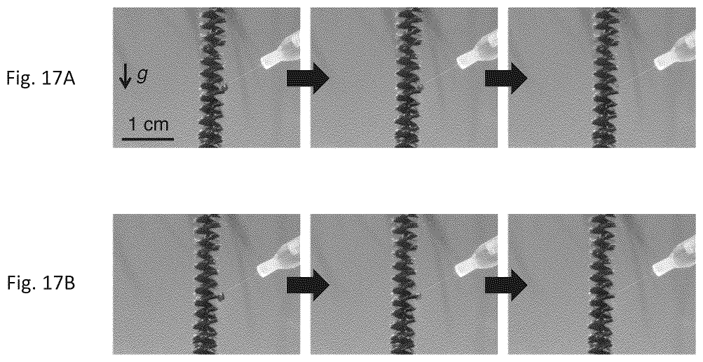

Fibers made of chenille stems or modified chenille stems with less hair show different morphography before and after collecting fog. FIG. 16A shows the before and after result of collecting fog with thin hairs of modified chenille stems with less hair in accordance with an illustrative embodiment. FIG. 16B shows the before and after result of collecting fog with thin hairs of regular chenille stems in accordance with an illustrative embodiment. The thin hairs of both the modified chenille stems with less hair and the regular chenille stems form clusters of approximately 10 hairs or more after getting wet. This capillarity-driven self-assembly behavior of thin hairs is determined by parameters including the hair length, hair diameter, hair density, and the stiffness of the hair material (i.e., Young's modulus), and thus, clusters cannot grow further after reaching the steady state. In the schematics of hair bundles in conical shapes made of multiple thin hairs (indicated by black lines), the Laplace pressure difference (ΔP_Laplace) within the liquid between two locations with approximate value of the local radii of R_1 and R_2 can be expressed as ΔP_Laplace= [symbol] _water (1/R_1−1/R_2) .

Because R_1 is smaller than R_2, ΔP_Laplace is positive, resulting in the fast liquid transport from hair bundle tips to the hairy wire core. It is noted that to simply explain the direction of the directional flow the inventors approximated the local radii of curvature necessary for calculating the sign of the Laplace pressure by using the radii of the two representative circles (i.e., conical sections). Thus, any area between these hair bundles, i.e., the space marked in dashed lines, is free of clogs once the droplet can be transported within hair bundles.

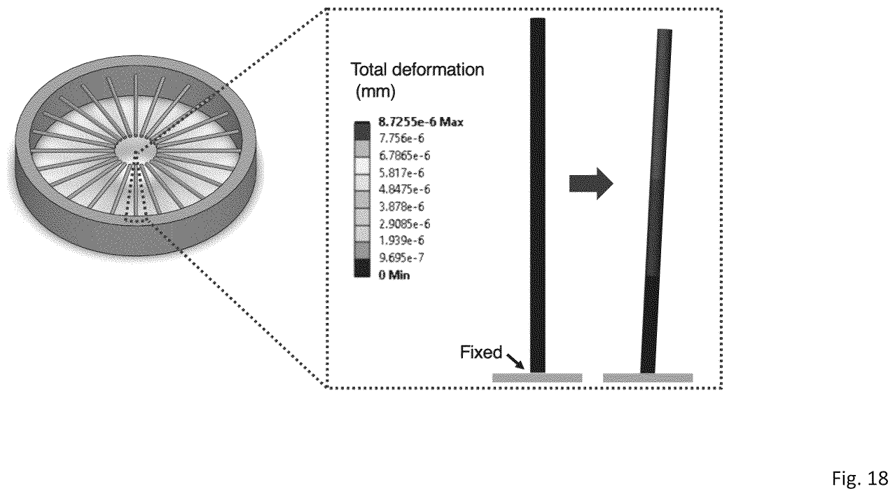

FIG. 17A shows a first view of the fast transport on fibers made of chenille stems after getting wet in accordance with an illustrative embodiment. FIG. 17B shows a second view of the fast transport on fibers made of chenille stems after getting wet in accordance with an illustrative embodiment. Time elapses in the views from left to right in both FIGS. 17A and 17B. The time difference between each view is roughly 16.67 milliseconds (ms). FIG. 18 shows results of a simulation of sample fiber deformation during fog collection (flow speed is set to 10 m/s) in accordance with an illustrative embodiment.

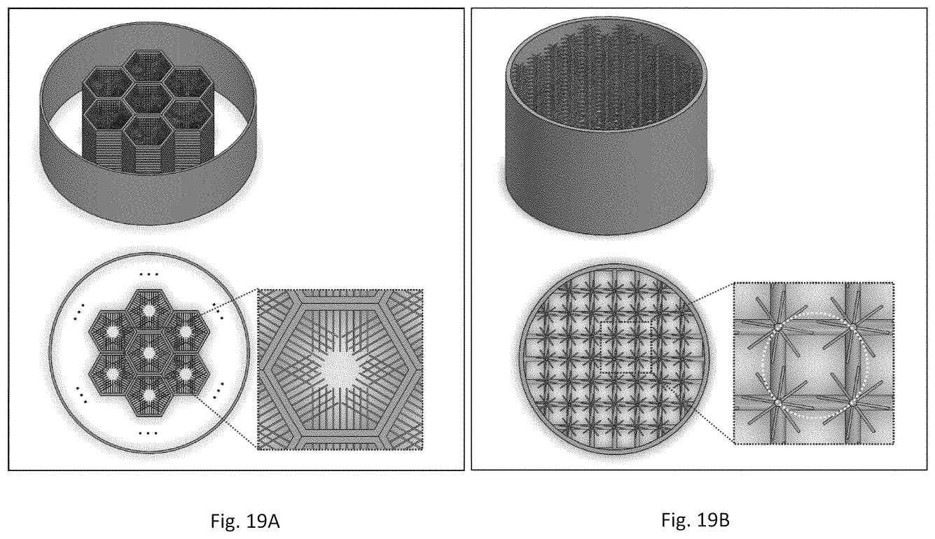

In an illustrative embodiment, the proposed design can easily be scaled up to be implemented within pipes of larger diameters as depicted in FIG. 19. Scale-up methods can include dividing the volume of a large pipe into a plurality of smaller pipes of varying cross-sectional geometries, and inserting a plurality of hair structures into a lattice formation throughout the volume of the pipe. FIG. 19A depicts dividing the volume of a large pipe into smaller pipes of varying cross-sectional geometries in accordance with an illustrative embodiment. As shown, a plurality of filters having a hexagonal shape are mounted adjacent to one another within the cylindrical base (or pipe). Each of the hexagonal filters includes fibers extending inward from each of the six walls that form the hexagon. In the embodiment, shown, the fibers extend such that the fibers extending from any given wall of the hexagonal base overlap with fibers that extend from two other (adjacent) walls of the hexagonal base.

FIG. 19B shows inserting multiple hair structures in a lattice formation throughout the volume of a larger pipe in accordance with an illustrative embodiment. As shown, each intersection of the lattice includes a plurality of fibers that extend into the open spaces of the lattice. It is noted that there are a plurality of fibers at each layer of the sample moving into the page, and the number of fibers per layer may vary.

Compared with other high-energy input methods, like desalination, the proposed systems require considerably less energy input and lower costs. Three-dimensional (3D) printing is an established and commonly-used process in additive manufacturing, and can be used to form components of the proposed system. This results in accessible large scale manufacturing for these surfaces at lower costs than other methods, and the potential for wide-scale implementation. This technology is not limited to pure mist, but also extends to water mixtures and solutions. An example of a mixture that can be eliminated through this collection process is smog, or a mixture of soot particles within a water droplet, i.e. liquid phase with particulates. As such, the proposed design could be applied to solve multiple problems including mist elimination and water collection, fog collection, air filtration, smog capture, etc.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more. ” The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention.

The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. A liquid collection system comprising:
a base through which a gas flows; and
a plurality of fibers extending from the base such that the plurality of fibers extend toward one another, wherein the plurality of fibers are positioned to capture liquid that is present in the gas that flows through the base.

2. The system of claim 1, wherein the base is a cylinder.

3. The system of claim 1, further comprising a fan that causes the gas to flow through the base.

4. The system of claim 1, further comprising a container to capture the collected liquid.

5. The system of claim 1, wherein the plurality of fibers comprises a first plurality of fibers that form a first filter layer within the base, and further comprising a second plurality of fibers extending from the base that form a second filter layer within the base.

6. The system of claim 5, wherein the first filter layer and the second filter layer have different numbers of fibers.

7. The system of claim 5, wherein the second filter layer is offset from the first layer by a rotational angle theta.

8. The system of claim 1, wherein the plurality of fibers includes fibers that vary in length.

9. The system of claim 1, wherein the plurality of fibers includes fibers that vary in diameter.

10. The system of claim 1, wherein at least one fiber in the plurality of fibers is tapered in diameter.

11. The system of claim 1, wherein at least one fiber in the plurality of fibers is formed from interconnected truncated cones.

12. The system of claim 1, wherein at least one fiber in the plurality of fibers comprises a chenille stem.

13. The system of claim 1, wherein the base comprises a hexagonal base, and further comprising a plurality of coplanar hexagonal bases mounted within a cylinder, wherein each of the hexagonal bases includes a distinct plurality of fibers.

14. A method of forming a liquid collection system, the method comprising:
forming a base through which a gas can flow; and
mounting a plurality of fibers to the base such that the plurality of fibers extend toward one another, wherein the plurality of fibers are positioned to capture liquid that is present in the gas.

15. The method of claim 14, further comprising forming the plurality of fibers such that the plurality of fibers includes fibers that vary in length.

16. The method of claim 14, further comprising forming the plurality of fibers such that the plurality of fibers includes fibers that vary in diameter.

17. The method of claim 14, wherein the plurality of fibers comprises a first plurality of fibers that form a first filter layer within the base, and further comprising mounting a second plurality of fibers to the base to form a second filter layer within the base.

18. The method of claim 14, wherein mounting the plurality of fibers comprises mounting at least one fiber at an angle gamma relative to the base.

19. The method of claim 18, wherein the plurality of fibers are mounted such that different fibers are mounted at different angles relative to the base.

20. The method of claim 14, wherein at least one fiber in the plurality of fibers comprises a chenille stem.
